(19) United States
(12) Patent Application Publication
(10) Pub. No.: US 2011/0010710 A1
(43) Pub. Date: Jan. 13, 2011

(54) Image Transfer Between Processing Devices

(75) Inventors: Glenn T. Thrush, Kirkland, WA (US); Wendy Ann Chruch, Redmond, WA (US); Mark Kyle Svancarek, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/501,394

(22) Filed: Jul. 10, 2009

(51) Int. Cl. G06F 9/455; G06F 12/16

(52) U.S. Cl. 718/1; 711/162; 711/E12.103

(57) ABSTRACT

Methods and devices are provided for copying an image of a medium of a first processing device to a virtual medium of a second processing device. Virtual machine configuration information may be created based on hardware configuration information from the first processing device. The image and the virtual machine configuration information may be copied, or written, to the virtual medium. Instructions may be provided to the second processing device for launching a virtual machine to execute an operating system copied from the image to the virtual medium. At least one executable application copied from the image to the virtual medium may be executed by the virtual machine launched on the second processing device. In some embodiments, the second processing device may provide remote access to the virtual machine for one or more remote processing devices.

### BACKGROUND

When users decide to retire their old processing devices and purchase new processing devices, the users would like to transfer all of their files to the new processing devices. However, the new processing devices do not have the users' favorite programs and settings from the old processing devices and simply transferring the files and the settings from the old processing devices to the new processing devices may create numerous problems for the users. For example, applications associated with at least some of the files may be missing from the new processing devices, and the new processing devices may have new files and new settings in addition to the transferred files and transferred settings (which is not quite the same as using the files and the settings on the original processing devices). As a result, many users hesitate to retire their old processing devices and continue maintaining the old processing devices for some period of time until, at least, the users are more comfortable with the new files and new settings of the new processing device.

In addition, some users may not fully retire their old processing devices because some old applications on the old processing devices may not be compatible with new processing devices. For example, if a user wishes to view an old tax return prepared with an old tax return preparation application on an old processing device, and the old tax return preparation application is not compatible with the new processing device, then the user may have no option other than to use the old tax return preparation application on the old processing device in order to view the tax return.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

In a first embodiment consistent with subject matter of this disclosure, methods and processing devices may be provided for moving an environment of a first processing device to a second processing device. A medium of the first processing device may include an operating system, hardware configuration information, and at least one executable application. The first processing device may create an image of the medium and may provide the image and the hardware configuration information to the second processing device. The second processing device may copy, or write, the image to a virtual medium and may create virtual machine configuration information based on the hardware configuration information. The virtual machine configuration information may be copied, or written, to the virtual medium. The second processing device may be provided with launching instructions for launching a virtual machine to execute the operating system copy to the virtual medium from the image. The virtual machine may execute one of the at least one executable application copied to the virtual medium from the image. In a variation of the first embodiment, the second processing device may provide, to a remote processing device, remote access to the virtual machine.

In a second embodiment consistent with the subject matter of this disclosure, a medium of a first processing device may include an operating system, hardware configuration information, and at least one executable application. The first processing device may create an image of the medium and may provide the image to a second processing device and the hardware configuration information to a third processing device. The second processing device may copy, or write, the image to a virtual medium. The third processing device may create virtual machine configuration information, based on the hardware configuration information, and may provide the virtual machine configuration information to the second processing device. The second processing device may copy, or write, the virtual machine configuration information to the virtual medium. The second processing device may be provided with launching instructions for launching a virtual machine to execute the operating system copied to the virtual medium from the image. The virtual machine may execute one of the at least one executable application copied to the virtual medium from the image.

In a third embodiment, a second processing device may receive backups of a medium of a first processing device. The medium of the first processing device may have stored thereon an operating system, hardware configuration information, and at least one executable application. The second processing device may create, from the backups, an image of the medium, as the medium existed on a given date, and may copy, or write, the image to a virtual medium. The second processing device may create a virtual machine configuration information based on the hardware configuration information copied from the image to the virtual medium. The second processing device may be provided with launching instructions for launching a virtual machine to execute the operating system copied to the virtual medium from the image. The virtual machine may execute one of the at least one executable application copied to the virtual medium from the image. Remote access to the virtual machine may be provided to a third processing device.

### DRAWINGS

In order to describe the manner in which the above-recited and other advantages and features can be obtained, a more particular description is described below and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 is a block diagram of an exemplary processing device, which may be used to implement embodiments consistent with the subject matter of this disclosure.

FIGS. 2-6 illustrate exemplary operating environment for various embodiments consistent with the subject matter of this disclosure.

FIGS. 7-10 are flowcharts that illustrate exemplary processing in various embodiments consistent with the subject matter of this disclosure.

### DETAILED DESCRIPTION

Embodiments are discussed in detail below. While specific implementations are discussed, it is to be understood that this is done for illustration purposes only. A person skilled in the relevant art will recognize that other components and configurations may be used without parting from the spirit and scope of the subject matter of this disclosure.

### Overview

In embodiments consistent with the subject matter of this disclosure, methods and devices are disclosed for copying an environment of an old processing device to a second processing device, such that the environment of the old processing device may be executed on the second processing device as a virtual machine upon which old applications from the old processing device may be executed to work with files and settings from the old processing device.

In a first embodiment, an image of a medium of the old processing device, such as a hard disk or other medium may be created. The medium may have stored thereon an operating system, a hardware configuration file, and one or more executable applications. The image may be copied to a virtual medium, such as, for example, a virtual disk or other virtual medium, of a new processing device. A virtual machine configuration file may be created from the hardware configuration file and copied, or written, to the virtual medium. Launching instructions may be created and stored on the new processing device. The launching instructions may include instructions for launching a virtual machine to execute the operating system and the one or more executable applications copied from the image of the medium of the old processing device to the virtual medium of the new processing device.

In a second embodiment, an old processing device, a server, and a new processing device may be connected to a network. The server may direct the old processing device to send, to the server, hardware configuration information and an image of a medium, such as a hard disk or other medium of the old processing device, to the new processing device. On the new processing device, the image may be copied to a virtual medium, such as, for example, a virtual disk or other virtual medium. The server may create a virtual machine configuration based on the hardware configuration information received from the old processing device. The server may provide the virtual machine configuration to the new processing device and may direct the new processing device to copy the virtual machine configuration to the virtual medium. The server may also provide launching instructions to the new processing device for launching a virtual machine to execute an operating system and one or more executable applications copied from the image to the virtual medium.

In a third embodiment, an old processing device, a server, and a new processing device may be connected to a network. Via the network, the server may configure the old processing device to periodically send backup information of a medium, such as a hard disk, to the server. The medium may have stored thereon an operating system, hardware configuration information, and at least one executable application. Based on the periodically sent backup information from the old processing device, the server may create an image of the medium as it existed on a given date and may copy the image to a virtual medium, such as, for example, a virtual disk or other virtual medium. The server may create a virtual machine configuration based on hardware configuration information copied from the image to the virtual medium and may write the virtual machine configuration to the virtual medium. The server may launch a virtual machine to execute the operating system copied from the image to the virtual medium. One or more of the at least one executable application copied from the image to the virtual medium may be executed by the virtual machine running on the server. The server may further provide a remote processing device, such as a user's new processing device or other processing device, with remote access to the virtual machine on the server.

In a variation of the third embodiment, instead of the server creating an image of the medium of the old processing device, the server may: direct the old processing device to create a complete image of a medium, such as, for example, a hard disk; send the image to the server, which may copy the image to a virtual medium, such as, for example, a virtual disk or other virtual medium; and direct the old processing device to send hardware configuration to the server, which may create virtual machine configuration information, based thereon, and write the virtual machine configuration information to the virtual medium.

In another embodiment, an old processing device and a new processing device may be connected via a network. The new processing device may: direct the old processing device to create an image of a medium, such as, for example, a hard disk or other medium; send the image to the new processing device, which may copy the image to a virtual medium, such as, for example, a virtual disk or other virtual medium; direct the old processing device to send hardware configuration to the new processing device, which may create a virtual machine configuration and may copy the virtual machine configuration to the virtual medium; and create launching instructions to launch a virtual machine on the new processing device to execute an operating system and one or more of at least one executable application copied from the image to the virtual medium.

### Exemplary Processing Devices

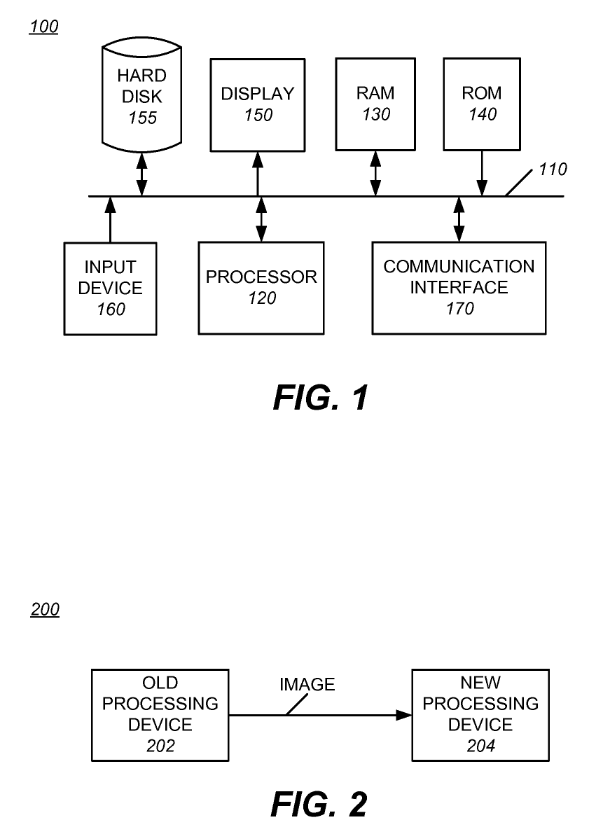

FIG. 1 is a block diagram of an exemplary processing device 100, which may be used in implementations of embodiments consistent with the subject matter of this disclosure. The processing device 100 may be a laptop personal computer (PC), a desktop personal computer, a server, or another type of processing device. Processing device 100 may include a bus 110, a processor 120, a random access memory (RAM) 130, a read only memory (ROM) 140, a display 150, a hard disk 155, an input device 160, and a communication interface 170. Bus 110 may connect processor 120, RAM 130, ROM 140, display 150, input device 160 and communication interface 170.

Processor 120 may include one or more conventional processors that interpret and execute instructions. A memory may include RAM 130, ROM 140, and/or another type of dynamic or static storage device that stores information and instructions for execution by processor 120. RAM 130, or another type of dynamic storage device, may store instructions as well as temporary variables or other intermediate information used during execution of instructions by processor 120. ROM 140, or another type of static storage device, may store static information and instructions for processor 120.

Display 150 may be a display device such as, for example, a plasma display, a liquid crystal display, a cathode ray tube (CRT), or other type of display device.

Hard disk 155 may have stored thereon an operating system, hardware configuration information, and at least one executable application.

Input device 160 may be a keyboard, a pointing device, or other type of input device. The pointing device may be, for example, a computer mouse, a trackball, or other pointing device.

Communication interface 170 may include a transceiver for transmitting and receiving data via a wireless or a wired network.

### Exemplary Operating Environments

FIG. 2 illustrates an exemplary operating environment 200 for one embodiment. Operating environment 200 may include an old processing device 202 and a new processing device 204. Old processing device 202 may create an image of a medium, such as, for example, a hard disk or other medium. The medium may have, stored thereon, an operating system, hardware configuration information, and at least one executable application. The image may be copied to a virtual medium of new processing device 204. New processing device 204 may create virtual machine configuration information, based on the hardware configuration information copied from the image to the virtual medium, and may write, or copy, the virtual machine configuration information to the virtual medium. New processing device 204 may execute instructions for launching a virtual machine to execute an operating system stored on the virtual medium. One or more of the at least one executable application may be executed by the virtual machine.

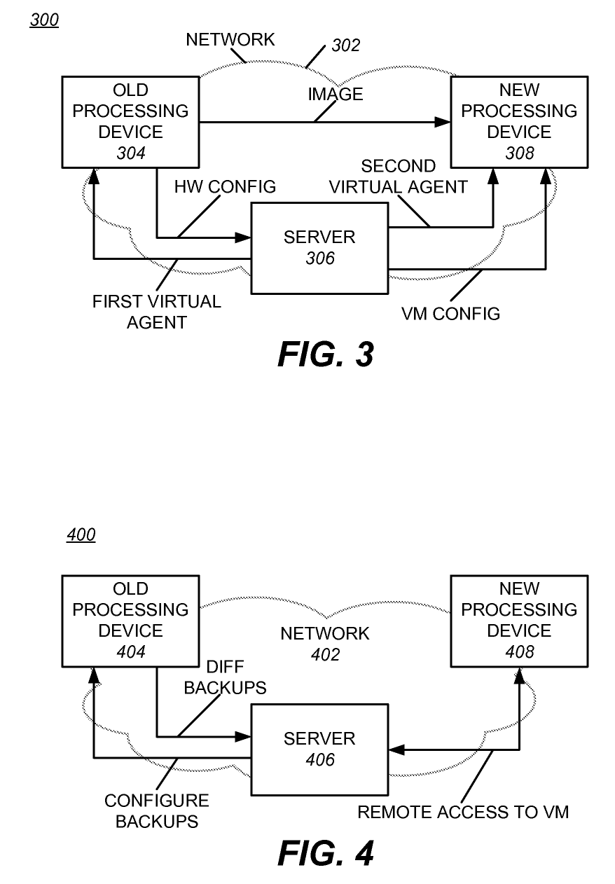

FIG. 3 illustrates an exemplary operating environment 300 for a second embodiment. Operating environment 300 may include a network 302, an old processing device 304, a server 306, and a new processing device 308. Old processing device 304, server 306, and new processing device 308 may be connected to network 302. Network 302 may include a local area network, a wide area network, a packet switching network, an ATM network, a frame relay network, a fiber optic network, a public switched telephone network, a wireless network, a wired network, another type of network, or any combination thereof.

In operating environment 300, server 306 may direct old processing device 304 to send hardware configuration information to server 306 and an image of a medium, such as, for example, a hard disk or other medium, to new processing device 308. To accomplish the above, server 306 may send a first virtual agent to old processing device 304 for installation thereon. Server 306 may direct new processing device 308 to receive and store the image of the medium by sending a second virtual agent to new processing device 308 for installation thereon.

The first virtual agent may create an image of a medium, such as, for example, a hard disk or other medium, of old processing device 304 and may send the image to new processing device 308. The image may include an operating system and at least one executable application copied from the medium. The first virtual agent may also send hardware configuration information from old processing device 304 to server 306.

The second virtual agent, executing on new processing device 308, may receive the image and may write the image to a virtual medium, such as, for example, a virtual disk or other virtual medium. Server 306 may create virtual machine configuration information, based on the hardware configuration information received form old processing device 304 and may send the virtual machine configuration information to new processing device 308. The second virtual agent, executing on new processing device 308, may receive the virtual machine configuration information and may write, or copy, the virtual machine configuration information to the virtual medium. Server 306 may also create and send, to new processing device 308, launching instructions for launching a virtual machine to execute an operating system copied from the image to the virtual medium.

The second virtual agent, executing on new processing device 308, may receive and save the launching instructions, such that a virtual machine may be launched to execute on new processing device 308. At least one executable application, stored on the virtual medium, may be executed under the virtual machine running on processing device 308.

FIG. 4 illustrates an exemplary operating environment 400 for a third embodiment. Operating environment 400 may include a network 402, an old processing device 404, a server 406, and a new processing device 408. Old processing device 404, server 406, and new processing device 408 may be connected to network 402. Network 402 may include a local area network, a wide area network, a packet switching network, an ATM network, a frame relay network, a fiber optic network, a public switched telephone network, a wireless network, a wired network, another type of network, or any combination thereof.

In operating environment 400, server 406 may direct old processing device 404 to periodically backup a medium of old processing device 404, such as, for example, a hard disk or other medium, to server 406. The medium may include an operating system, hardware configuration information, and at least one executable application. Server 406 may direct old processing device 404 to backup the medium by sending, to old processing device 404, information for configuring a backup operation. Server 406 may periodically receive full backups and/or differential backups from old processing device 404.

At some point, server 406 may create an image of the medium of old processing device 404, as it existed on a given date. Server 406 may write, or copy, the image to a virtual medium, such as, for example, a virtual disk. Server 406 may create and store virtual machine configuration information based on hardware configuration information copied from the image to the virtual medium. Server 406 may also create and store launching instructions for launching a virtual machine to execute the operating system copied from the image to the virtual medium. One of the at least one executable application copied from the image to the virtual medium may be executed by the virtual machine running on server 406. Server 406 may provide, to new processing device 408 or another processing device, remote access to the virtual machine.

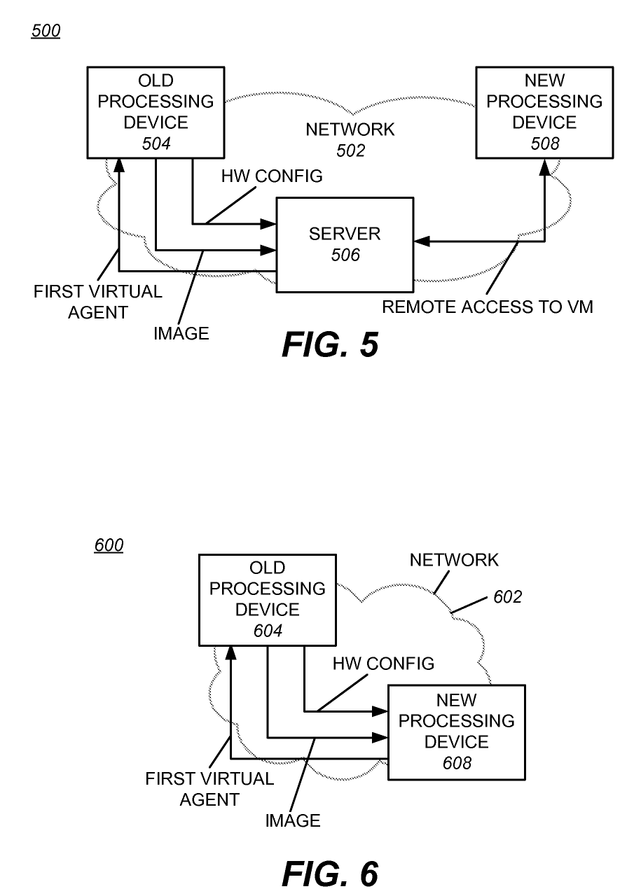

FIG. 5 illustrates an exemplary operating environment 500 for a fourth embodiment. Operating environment 500 may include a network 502, an old processing device 504, a server 506, and a new processing device 508. Old processing device 504, server 506, and new processing device 508 may be connected to network 502. Network 502 may include a local area network, a wide area network, a packet switching network, an ATM network, a frame relay network, a fiber optic network, a public switched telephone network, a wireless network, a wired network, another type of network, or any combination thereof.

In operating environment 500, server 506 may direct old processing device 504 to create an image of a medium, such as, for example, a hard disk or other medium by sending a first virtual agent to old processing device 504 for installation thereon. The first virtual agent may create the image of the medium of old processing device 504 and may send the image to server 506 via network 502. The image may include an operating system and at least one executable application copied from the medium. The first virtual agent may also send hardware configuration information from old processing device 504 to server 506 via network 502.

Server 506 may receive the image and may write the image to a virtual medium, such as, for example, a virtual disk or other virtual medium. Server 506 may receive the hardware configuration information and may create virtual machine configuration information based on the received hardware configuration information. Server 506 may write, or copy, the virtual machine configuration information to the virtual medium. Server 306 may also create and store launching instructions for launching a virtual machine to execute an operating system copied from the image to the virtual medium. One or more of the at least one executable application, copied from the image to the virtual medium, may execute under the virtual machine running on server 306. Server 306 may provide, to new processing device 508 or another processing device, remote access to the executing virtual machine.

FIG. 6 illustrates an exemplary operating environment 600 for a fifth embodiment. Operating environment 600 may include a network 602, an old processing device 604, and a new processing device 608. Old processing device 604, server 606, and new processing device 608 may be connected to network 602. Network 602 may include a local area network, a wide area network, a packet switching network, an ATM network, a fiber optic network, a public switched telephone network, a wireless network, a wired network, another type of network, or any combination thereof.

In operating environment 600, new processing device 608 may direct old processing device 604 to create an image of a medium, such as, for example, a hard disk or other medium by sending a first virtual agent to old processing device 604 for installation thereon. The first virtual agent may create the image of the medium of old processing device 604 and may send the image to new processing device 608 via network 602. The image may include an operating system and at least one executable application copied from the medium. The first virtual agent may also send hardware configuration information from old processing device 604 to new processing device 608 via network 602.

New processing device 608 may receive the image and may write, or copy, the image to a virtual medium, such as, for example, a virtual disk or other virtual medium. New processing device 608 may receive the hardware configuration information and may create virtual machine configuration information based thereon. New processing device 608 may then write, or copy, the virtual machine configuration information to the virtual medium. New processing device 608 may also create and store launching instructions for launching a virtual machine to execute an operating system copied from the image to the virtual medium. One or more of the at least one executable application, copied from the image to the virtual medium, may execute under the virtual machine running on new processing device 608.

### Exemplary Processing

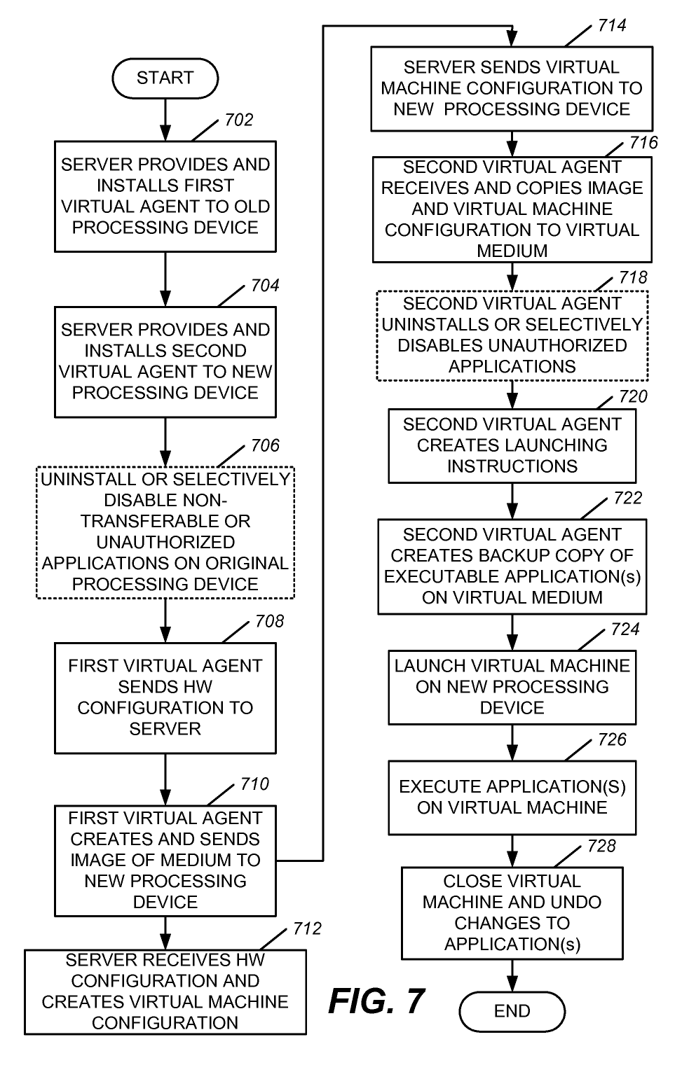

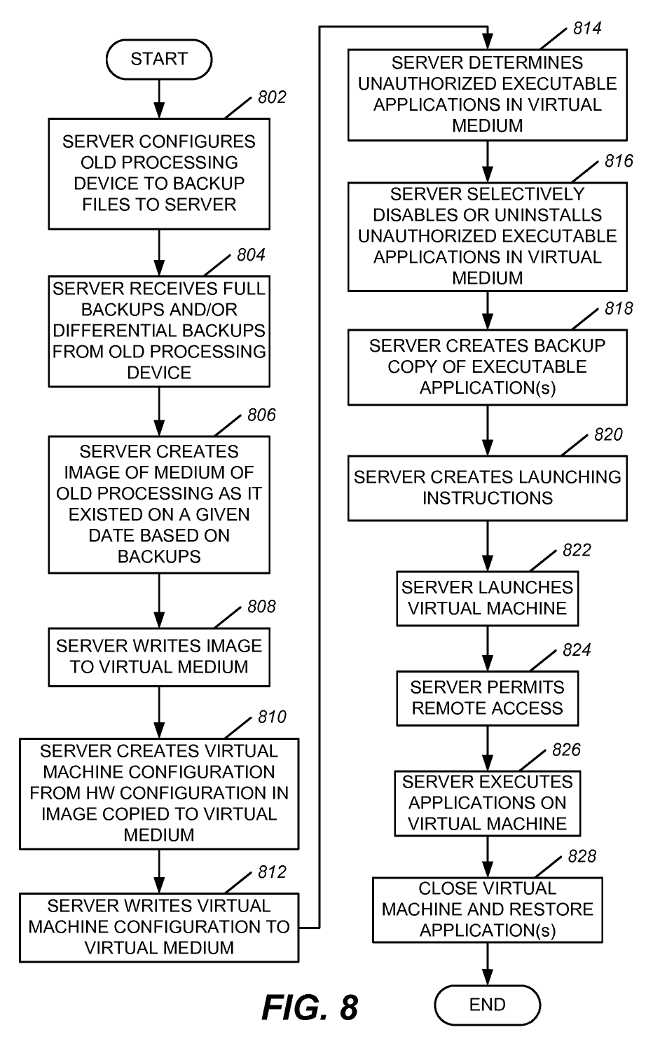

FIG. 7 is a flowchart illustrating an exemplary process which may be performed in an embodiment. The embodiment may be in an operating environment, such as, for example, operating environment 300.

The process may begin with a server providing a first virtual agent to an old processing device and installing the first virtual agent on the old processing device (act 702). Next, a server may provide a second virtual agent to a new processing device and may install the second virtual agent on the new processing device (act 704).

Applications that are not transferable, or not authorized for use on a processing device other than the old processing device, may be uninstalled or selectively disabled on the old processing device or on the new processing device. Thus, in various embodiments either act 706 or act 718, but not both, may be performed. If, in this embodiment, applications that are not transferable, or not authorized for use on a processing device other than the old processing device, are to be uninstalled or selectively disabled on the old processing device, then the first virtual agent may uninstall or selectively disable such applications (act 706).

The first virtual agent may send hardware configuration information from the old processing device to the server, connected via a network (act 708). The first virtual agent may create a complete image of a medium, such as, for example, a hard disk or other medium, and may send the image to the new processing device (act 710). The image may include an operating system and at least one executable application. The server may receive the hardware configuration information and may create virtual machine configuration information based on the hardware configuration information (act 712). The server may send the virtual machine configuration information to the new processing device via the network (act 714).

The second virtual agent, executing on the new processing device, may receive the image and the virtual machine configuration information and may write, or copy, the image and the virtual machine configuration information to an empty virtual medium, such as, for example, a virtual disk or other virtual medium (act 716).

If, in this embodiment, act 706 was not performed, then the second virtual agent may uninstall or selectively disable unauthorized executable applications, or non-transferable executable applications, written to the virtual medium (act 718).

The second virtual agent may then create launching instructions for launching a virtual machine to execute the operating system copied from the image to the virtual medium (act 720). The second virtual agent may then create a backup copy of one or more of the at least one executable application copied from the image to the virtual medium (act 722). The launching instructions may then be executed on the new processing device to launch the virtual machine (act 724). One or more of the at least one executable application may be executed on the virtual machine running on the new processing device upon receiving an indication to execute the one or more of the at least one executable application (act 726).

At a later point in time, the virtual machine executing on the new processing device may be closed and the new processing device may undo any changes to the one or more of the at least one executable application (act 728). The new processing device may undo any changes to the one or more of the at least one executable application by restoring the one or more of the at least one executable application from the backup copy of the one or more of the at least one executable application. The process may then be completed.

FIG. 8 is a flowchart illustrating an exemplary process which may be performed in an embodiment. The embodiment may be in an operating environment, such as, for example, operating environment 400.

The process may begin with a server configuring an old processing device to backup files of a medium, such as, for example, a hard disk or other medium, to the server via a network (act 802). Next, the server may periodically receive full backups and/or differential backups from the old processing device via the network (act 804). The server may create a complete image of the medium of the old processing device, as the medium existed on a given date, based upon the backups (act 806). The image may include an operating system, configuration information, and at least one executable application from the medium. The server may write, or copy, the created image to a virtual medium, such as, for example, a virtual disk or other virtual medium (act 808).

Next, the server may create virtual machine configuration information based on the hardware configuration information copied from the image to the virtual medium (act 810). The server may then write, or copy the virtual machine configuration information to the virtual medium (act 812). The server may examine licensing information, or may examine a list of authorized or unauthorized applications to determine whether any of the at least one executable application on the virtual medium are unauthorized (act 814). The server may then selectively disable, or uninstall, unauthorized ones of the at least one executable application on the virtual medium (act 816).

Next, the server may create a backup copy of the at least one executable application on the virtual medium (act 818). The server may then create instructions for launching a virtual machine to execute the operating system copied from the image to the virtual medium (act 820). The server may then execute the created instructions to launch the virtual machine to execute the operating system on the virtual medium (act 822) and may permit remote access to the virtual machine by a new processing device, or other processing device, via a network (act 824). The server may execute one or more of the at least one executable application, on the virtual machine, upon receiving an indication from the new processing device or the other processing device to execute the one or more of the at least one executable application (act 826).

At a later time, the virtual machine may be closed and the one or more of the at least one executable application may be restored from the backup copy of the one or more of the at least one executable applications (act 828). The process may then be completed.

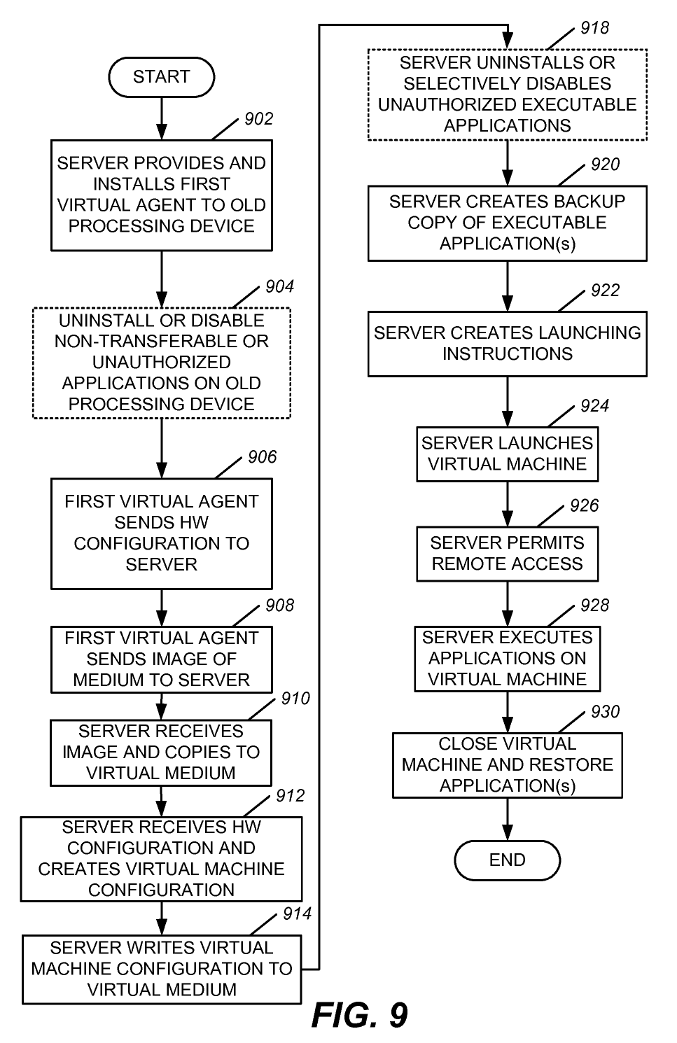

FIG. 9 is a flowchart illustrating an exemplary process which may be performed in an embodiment. The embodiment may be in an operating environment, such as, for example, operating environment 500.

The process may begin with a server providing a first virtual agent to an old processing device, via a network, and installing the first virtual agent on the old processing device (act 902).

Applications that are not transferable, or not authorized for use on a processing device other than the old processing device, may be uninstalled, or selectively disabled, on the old processing device or on the server. Thus, in various embodiments either act 904 or act 918, but not both, may be performed. If, in this embodiment, applications that are not transferable, or not authorized for use on a processing device other than the old processing device, are to be uninstalled, or selectively disabled, on the old processing device, then the first virtual agent may uninstall, or selectively disable, such applications (act 904).

The first virtual agent may then send hardware configuration information to the server, via a network (act 906). The first virtual agent may create an image of a medium, such as, for example, a hard disk or other medium, and may send the image to the server (act 908). The server may receive the image and copy, or write, the image to an empty virtual medium, such as, for example, a virtual disk or other medium (act 910). The server may receive the hardware configuration information and may create virtual machine configuration information based on the hardware configuration information (act 912). The server may copy, or write the virtual machine configuration information to the virtual medium (act 914).

If, in this embodiment, act 906 was not performed, then the server may uninstall, or selectively disable, unauthorized executable applications, or non-transferable executable applications, written, or copied, to the virtual medium from the image (act 918). The server may determine which of the executable applications are unauthorized, or non-transferable, based on licensing information on the virtual medium, a list of authorized or unauthorized executable applications on the virtual medium, or other information.

Next, the server may create a backup copy of the executable applications on the virtual medium (act 920). The server may then create instructions for launching a virtual machine to execute the operating system copied from the image to the virtual medium (act 922). The server may execute the created instructions to launch the virtual machine (act 924) and may permit remote access to the virtual machine by a new processing device, or other processing device, via the network (act 926). The server may execute one or more of the executable applications, on the virtual machine, upon receiving an indication from the new processing device or the other processing device to execute the one or more of the executable application (act 928).

At a later time, the virtual machine may be closed and the one or more of the executable applications may be restored from the backup copy of the executable applications (act 930). The process may then be completed.

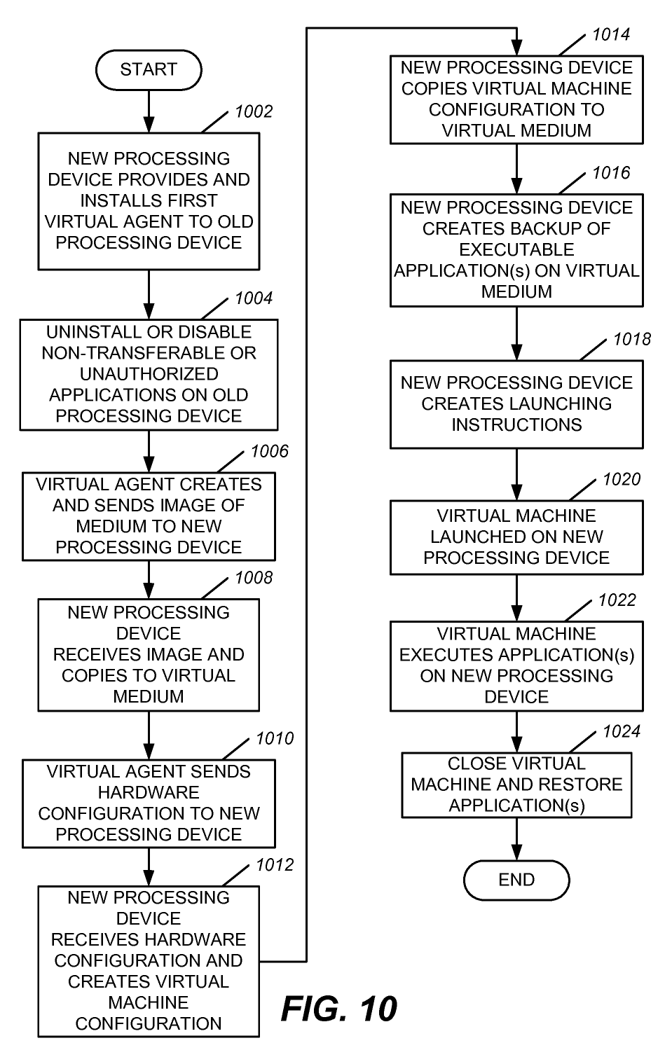

FIG. 10 is a flowchart illustrating an exemplary process which may be performed in an embodiment. The embodiment may be in an operating environment, such as, for example, operating environment 600. The process may begin with a new processing device providing a virtual agent to an old processing device, via a network, and installing the virtual agent on the old processing device (act 1002).

The virtual agent may uninstall or selectively disable non-transferable applications, or applications that are not authorized to be executed on another processing device, residing on a medium of the old processing device, such as, for example, a hard disk or other medium (act 1004). The virtual agent may then create a complete image of the medium and may send the image to the new processing device via the network (act 1006). The new processing device may receive the image and copy, or write the image to a virtual medium, such as, for example, a virtual disk, or other virtual medium (act 1008). The virtual medium may be empty before writing the image thereto.

The virtual agent may send hardware configuration information to the new processing device (act 1010). The new processing device may receive the hardware configuration information and may create virtual machine configuration information based on the received hardware configuration information (act 1012). The new processing device may copy, or write, the virtual machine configuration information to the virtual medium (act 1014).

Next, the new processing device may create backup copies of one or more executable applications on the virtual medium (act 1016). The new processing device may then create instructions to launch a virtual machine to execute an operating system copied from the image to the virtual medium (act 1018). Next, the new processing device may execute the created instructions to launch the virtual machine (act 1020). The virtual machine executing on the new processing device may execute one or more of the executable applications on the virtual medium, upon receiving an indication to execute the one or more of the at least one executable application (act 1022).

At a later time, the virtual machine may be closed and the one or more of the executable applications may be restored from the backup copies of the one or more of the executable applications (act 1024). The process may then be completed.

### CONCLUSION

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Other configurations of the described embodiments are part of the scope of this disclosure. For example, in other embodiments, an order of acts performed by a process, such as the processes illustrated in FIGS. 7-10, may be different, may be performed in a different order, and/or may include additional or other acts.

Accordingly, the appended claims and their legal equivalents define embodiments, rather than any specific examples given.

We claim as our invention:

1. A method of creating a virtual machine from an image of a first tangible medium of a first processing device, the method comprising:
copying, by a second processing device to a virtual medium of the second processing device, an image of a first tangible medium of a first processing device, the image including an operating system, at least one executable application, and hardware configuration information from the first tangible medium;
creating, by the second processing device, a virtual machine configuration based on the hardware configuration information of the first processing device;
copying, by the second processing device, the virtual machine configuration to the virtual medium; and
launching, on the second processing device, the virtual machine by executing launching instructions, the virtual machine executing the operating system copied to the virtual medium.

2. The method of claim 1, wherein:
the first tangible medium is a hard disk, and
the virtual medium is a virtual hard disk.

3. The method of claim 1, wherein:
any non-transferable applications were uninstalled or disabled on the first processing device before creating the image of the first tangible medium.

4. The method of claim 1, further comprising:
executing one of the at least one executable application on the virtual machine launched on the second processing device.

5. The method of claim 1, further comprising:
closing, on the second processing device, the virtual machine; and
undoing, by the second processing device, any changes made to the at least one executable application stored on the virtual medium.

6. The method of claim 5, further comprising:
creating, by the second processing device, a backup copy of the at least one executable application stored on the virtual medium before executing the at least one executable application, wherein
the undoing of any changes made to the at least one application stored on the virtual medium further comprises:
restoring, the at least one application stored on the virtual medium, from the backup copy of the at least on executable application.

7. The method of claim 1, the method further comprises:
determining, on the second processing device, whether any of the at least one executable application are not authorized for execution on the second processing device, and
selectively disabling, on the second processing device, ones of the at least one application that are determined not to be authorized for execution on the second processing device.

8. A processing device comprising:
a processor; and
at least one medium connected to the processor, the at least one medium comprising:
instructions for creating, by the processing device from at least one backup file, a complete image, as of a given date, of a tangible medium of a second processing device, the complete image including an operating system, at least one executable application, and hardware configuration information,
instructions for copying the created complete image to an empty virtual medium of the processing device,
instructions for creating virtual machine configuration information based on the hardware configuration information copied to the virtual medium from the created complete image,
instructions for writing the virtual machine configuration information to the virtual medium, and
instructions for launching the virtual machine on the processing device, the virtual machine to be executing the operating system copied to the virtual medium from the created complete image.

9. The processing device of claim 8, wherein the at least one medium further comprises:
instructions for providing, to a remote processing device, remote access to the launched virtual machine.

10. The processing device of claim 9, further comprising:
instructions for executing one of the at least one executable application on the virtual machine upon receiving an indication from the remote processing device to execute the one of the at least one executable application.

11. The processing device of claim 8, wherein the virtual medium is a virtual disk.

12. The processing device of claim 8, wherein the at least one medium further comprises:
instructions for determining whether any of the at least one executable application are not authorized to be executed by the virtual machine, and
instructions for selectively disabling ones of the at least one executable application that are not authorized to be executed by the virtual machine.

13. The processing device of claim 8, wherein the at least one medium further comprises:
instructions for determining whether any of the at least one executable application are not authorized to be executed by the virtual machine, and
instructions for uninstalling ones of the at least one executable application that are not authorized to be executed by the virtual machine.

14. A tangible machine-readable medium having instructions stored thereon for at least one processor, the instructions comprising:
instructions for providing a virtual agent to a first processing device for installation and execution thereon, the virtual agent including instructions for copying hardware configuration information to a second processing device and instructions for copying and sending a complete image of a hard disk of the first processing device to one of the second processing device or a third processing device, the complete image of the hard disk including an operating system and at least one executable application;
instructions for receiving hardware configuration information from the virtual agent executing on the first processing device;
instructions for creating a virtual machine configuration based on the received hardware configuration; and
instructions for providing the created virtual machine configuration to the one of the second processing device or the third processing device.

15. The tangible machine-readable medium of claim 14, wherein the virtual agent further comprises:
instructions for uninstalling ones of the at least one executable application not authorized for execution on a processing device other than the first processing device before executing the instructions for copying the complete image of the hard disk of the first processing device to the one of the second processing device or the third processing device.

16. The tangible machine-readable medium of claim 14, wherein:
the one of the second processing device and the third processing device is the third processing device, and
the instructions further comprise:
instructions for providing a second virtual agent to the third processing device, the second virtual agent comprising:
instructions for receiving, at the third processing device, the complete image of the hard disk from the first processing device and writing the complete image of the hard disk to a virtual disk,
instructions for receiving, at the third processing device, the virtual machine configuration and writing the virtual machine configuration to the virtual disk, and
instructions for launching a virtual machine that executes the operating system stored on the complete image of the hard disk copied to the virtual disk.

17. The tangible machine-readable medium of claim 16, wherein the second virtual agent further comprises:
instructions for uninstalling unauthorized ones of the at least one executable application from the virtual machine.

18. The tangible machine-readable medium of claim 16, wherein the second virtual agent further comprises:
instructions for selectively disabling unauthorized ones of the at least one executable application from the virtual machine.

19. The tangible machine-readable medium of claim 14, wherein:
the one of the second processing device or the third processing device is the second processing device, and
the instructions further comprise:
instructions for receiving the complete image of the hard disk from the first processing device and for writing the complete image of the hard disk to a virtual disk of the second processing device,
instructions for writing the virtual machine configuration to the virtual disk, and
instructions for launching a virtual machine that executes the operating system stored on the complete image of the hard disk copied to the virtual disk.

20. The tangible machine-readable medium of claim 19, wherein the instructions further comprise:
instructions to provide, to a remote processing device, remote access to the launched virtual machine.
